(19) United States
(12) Patent Application Publication
(10) Pub. No.: US 2015/0110325 A1
(43) Pub. Date: Apr. 23, 2015

(54) Speaker and Speaker Net

(71) Applicant: Yamaha Corporation, Hamamatsu-shi (JP)

(72) Inventors: Yasuo SHIOZAWA, Heverlee (BE); Akira MIKI, Hamamatsu-shi (JP); Hirofumi ONITSUKA, Hamamatsu-shi (JP)

(21) Appl. No.: 14/515,976

(22) Filed: Oct. 16, 2014

(30) Foreign Application Priority Data
Oct. 18, 2013 (JP) 2013-217237

(51) Int. Cl. H04R 1/02

(52) U.S. Cl. CPC H04R 1/02
USPC 381/335

(57) ABSTRACT

A speaker includes: one or more speaker units; a cabinet accommodating the one or more speaker units; and a speaker net mounted on one of the cabinet and at least one of the one or more speaker units so as to cover a sound emitting surface of each of the at least one of the one or more speaker units. The speaker net includes: a frame surrounding the sound emitting surface of each of the at least one of the one or more speaker units; and a sheet member stuck to the frame to cover the sound emitting surface of each of the at least one of the one or more speaker units. The frame being formed with at least one through hole establishing communication between (i) a space between the frame and the cabinet and (ii) a space outside the speaker.

### CROSS REFERENCE TO RELATED APPLICATION

The present application claims priority from Japanese Patent Application No. 2013-217237, which was filed on Oct. 18, 2013, the disclosure of which is herein incorporated by reference in its entirety.

### BACKGROUND

1. Technical Field

The present invention relates to a technique for protecting a speaker unit of a speaker and improving an appearance thereof while adjusting sound quality.

2. Description of the Related Art

In order to protect speaker units or drivers and improve appearances of speakers, conventional speakers in most cases are provided with speaker nets for covering sound emitting surfaces of the respective speaker units. For example, in the case of a speaker in which a single speaker unit is stored in a cabinet having a rectangular parallelepiped shape, the speaker is provided with a speaker net including: a rectangular frame formed along outer edges of a cabinet so as to surrounding a sound emitting surface of the speaker unit; and a sheet member (formed of metal mesh, saran net, or cloth, for example) pasted to an opening portion of the frame so as to cover the entire sound emitting surface. The construction in which such a speaker net is mounted on the speaker avoids direct contact of user's finger with the speaker unit, protecting the speaker unit. Also, suitable material, texture, and coloring of the sheet member improve an appearance of the speaker. Furthermore, the speaker net hides a large speaker unit, e.g., a woofer such that the speaker unit does not directly meet the eyes of the user, resulting in reduced degree of intimidation against the user.

### SUMMARY

While the speaker net thus plays an important role in, e.g., protecting a speaker unit and improving an appearance of the speaker, the speaker net mounted on the speaker may disadvantageously lower quality of sound traveling to a listener. Specifically, in the state in which the speaker net is mounted, sound pressure in a portion of a high frequency range greatly lowers, and sound in a low frequency range becomes less clear when compared with a state in which the speaker net is not mounted. In order to improve sound quality, some listeners use the speaker in the state in which the speaker net is removed. However, the removal of the speaker net is not preferable because of insufficient protection of the speaker unit.

This invention has been developed to provide a technique capable of both protecting a speaker unit of a speaker and avoiding deterioration of sound quality of reproduced sound.

The present invention provides a speaker including: one or more speaker units; a cabinet accommodating the one or more speaker units; and a speaker net mounted on one of the cabinet and at least one of the one or more speaker units so as to cover a sound emitting surface of each of the at least one of the one or more speaker units. The speaker net includes: a frame surrounding the sound emitting surface of each of the at least one of the one or more speaker units; and a sheet member stuck to the frame to cover the sound emitting surface of each of the at least one of the one or more speaker units. The frame is formed with at least one through hole establishing communication between (i) a space between the frame and the cabinet and (ii) a space outside the speaker.

The present invention also provides a speaker net to be mounted on one of a cabinet accommodating one or more speaker units and at least one of the one or more speaker units to cover a sound emitting surface of each of the at least one of the one or more speaker units. The speaker net includes: a frame surrounding the sound emitting surface of each of the at least one of the one or more speaker units; and a sheet member stuck to the frame to cover the sound emitting surface of each of the at least one of the one or more speaker units. The frame is formed with at least one through hole establishing communication between (i) a space between the frame and the cabinet and (ii) a space outside the speaker.

### BRIEF DESCRIPTION OF THE DRAWINGS

FIGS. 1A-1C are views illustrating results of experiments for verifying effects produced on sound quality by a frame and a sheet member of a speaker net;

FIG. 2 is a view for explaining consideration of the effects produced on sound quality by the frame;

FIGS. 3A and 3B are views illustrating distribution of sound pressure in a case where the frame is provided and in a case where the frame is not provided;

FIG. 4A is a front elevational view of a frame of a speaker net of a speaker according to one embodiment of the present invention, FIGS. 4B and 4C are front elevational views of the speaker net, FIG. 4D is a perspective view of the frame, and FIG. 4E is a view for explaining consideration of effects produced on sound quality by the frame;

FIG. 5 is a view for explaining effects of the frame; and

FIG. 6 is a view for explaining effects of the frame.

### DETAILED DESCRIPTION OF THE EMBODIMENT

Experiment and consideration of the inventors of the present invention have shown that, in a conventional speaker including a speaker net, a gap formed between a frame of the speaker net and a surface of the cabinet (i.e., a space between the frame and the cabinet) deteriorates sound quality. In the conventional speaker, as will be explained later in detail, acoustic impedance greatly changes near an opening portion of the gap which is formed at a side face of the speaker and which opens to an outside space. Thus, reflection of sound radiated from speaker units occurs at the open end. This reflected sound encounters and overlaps sound directly transmitted from the speaker units, whereby distribution of sound pressure with nodes and antinodes as in the acoustic mode occurs in front of the speaker, which deteriorates sound quality.

In a speaker of the present invention, a space corresponding to the gap communicates with a space outside the speaker (hereinafter may be referred to as “outside space”) by at least one through hole formed in the frame and is united with the outside space. Thus, the acoustic impedance does not greatly change near the opening portion formed at the side face of the speaker, preventing the reflection of sound at the open end. Consequently, the distribution of sound pressure as in the acoustic mode does not occur in front of the speaker, preventing the deterioration of sound quality. Also, the speaker net according to the present invention of course protects the speaker units. According to the present invention, it is possible to protect the speaker units of the speaker and avoid the deterioration of sound quality of reproduced sound.

It is noted that Patent Document 1 (Japanese Patent Application Publication No. 3-292097) includes a description suggesting that a gap formed between a frame of a speaker net (a speaker grille in Patent Document 1) and a surface of a cabinet deteriorates sound quality. However, Patent Document 1 does not identify how the sound quality is deteriorated, and the speaker grille disclosed in Patent Document 1 does not have the construction for avoiding the above-described sudden change of acoustic impedance. That is, the invention disclosed in Patent Document 1 differs from the present invention.

Hereinafter, there will be described one embodiment of the present invention by reference to the drawings.

### Identification of Cause of Deterioration of Sound Quality

A speaker net of a speaker is constituted by a frame and a sheet member. Here, the problem is that it is not adequately clarified which causes the deterioration of sound quality due to the speaker net among the frame, the sheet member, and interaction of the frame and the sheet member and how the deterioration is caused. To clarify these, the inventors of the present invention have conducted the following experiment.

The inventors of the present invention have measured frequency characteristics or response in a case (A) where the speaker from which the speaker net is removed is placed in an anechoic chamber and controlled to emit sound, in a case (B) where the speaker including the cabinet on which only the frame is mounted (i.e., on which the speaker net having no sheet member is mounted) is placed in the anechoic chamber and controlled to emit sound, and in a case (C) where the speaker on which the speaker net is mounted is placed in the anechoic chamber and controlled to emit sound. In each of the cases (A)-(C), a microphone is placed at a position spaced apart from a sound emitting surface of the speaker by a distance of 1.5 m in a direction of a directional axis of the speaker and picks up sound reproduced by the speaker to measure the frequency characteristics.

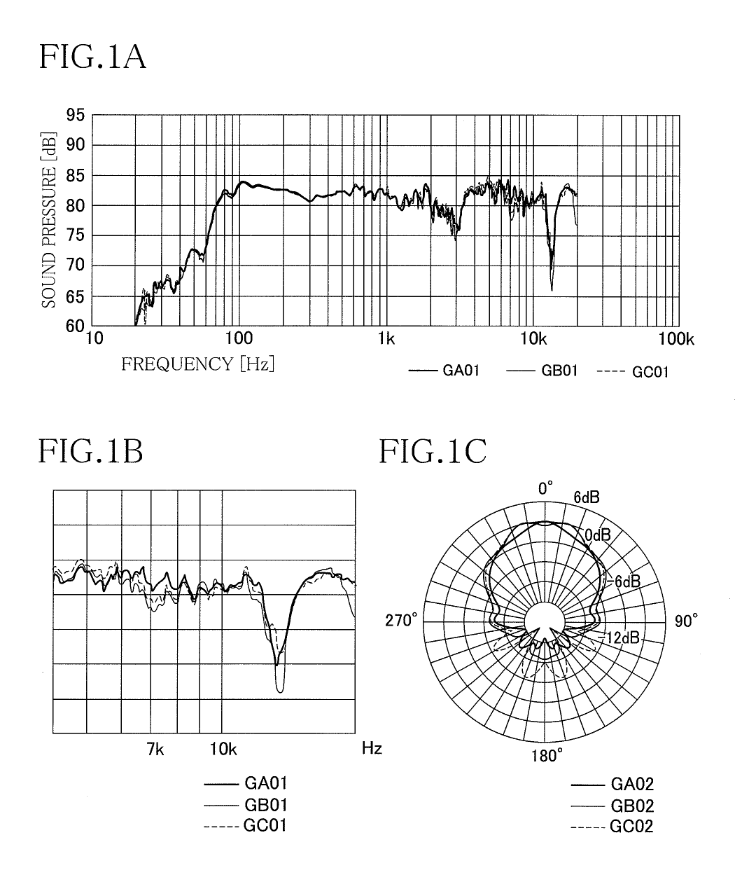

FIG. 1A illustrates graphs representing the frequency characteristics measured in the cases (A), (B), and (C). A graph GA01 in FIG. 1A (indicated by the thick solid line in FIG. 1A) represents the frequency characteristics in the case (A) where the speaker net is removed. A graph GB01 in FIG. 1A (indicated by the thin solid line in FIG. 1A) represents the frequency characteristics in the case (B) where only the frame is mounted. A graph GC01 in FIG. 1A (indicated by the broken line in FIG. 1A) represents the frequency characteristics in the case (C) where the speaker net is mounted.

As apparent when comparing the graph GB01 and the graph GC01 with each other, the presence or absence of the sheet member little affects the frequency response. In contrast, peaks and dips not appearing in the graph GA01 appear in the graph GB01 and the graph GC01 at a frequency range near 7 kHz. FIG. 1B is an enlarged view illustrating the frequency response near 7-10 kHz and clearly showing a difference between the graph GA01 and the graphs GB01, GC01.

The inventors of the present invention then have measured directional characteristics by causing the microphone to pick up sound having a frequency of 7 kHz while sequentially changing the location of the microphone in the clockwise direction from a direction of the directional axis of the speaker units which is defined as an angle of 0°. FIG. 1C illustrates the result of this measurement. A graph GA02 in FIG. 1C represents directional characteristics in the case (A) where the speaker net is removed. A graph GB02 in FIG. 1C represents directional characteristics in the case (B) where only the frame is mounted. A graph GC02 in FIG. 1C represents directional characteristics in the case (C) where the speaker net is mounted. As apparent in FIG. 1C, the directional characteristics also have a tendency similar to that of the frequency characteristics in FIG. 1A, i.e., an irregular variation of the characteristics due to the frame. On the basis of the result of the above-described experiment, the inventors of the present invention have concluded that the deterioration of sound quality in the case where the speaker net is mounted is caused primarily by the frame.

### Consideration of Sound-Quality-Deterioration Generation Mechanism

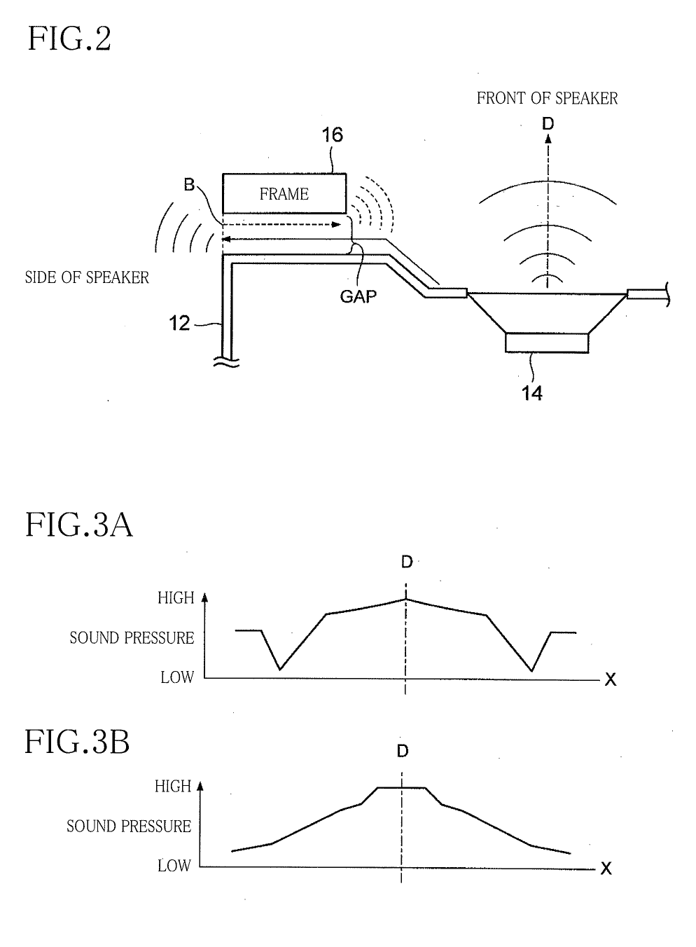

The inventors of the present invention have then considered how the frame deteriorates the sound quality. FIG. 2 is a view for explaining the consideration, and FIG. 2 schematically illustrates propagation of sound waves radiated from speaker units. It is noted that FIG. 2 omits illustration of the sheet member for simplicity. As illustrated in FIG. 2, sound waves radiated from the speaker units 14 spherically propagate and travel in a direction of a directional axis D of the speaker units. In FIG. 2, solid lines indicate wave surfaces and a direction of the propagation of original sound (or directly transmitted sound) radiated from the speaker units 14. A side of the speaker units 14 in the direction of the directional axis D of the speaker units 14 may be hereinafter referred to as “front side (face) of the speaker” or “in front of the speaker”, and a direction perpendicular to the direction of the directional axis D may be hereinafter referred to as “right or left side (side face) of the speaker”.

In the construction in which the speaker net is mounted on the speaker, the sound waves radiated from the speaker units 14 enter into a space formed between a surface of a cabinet 12 of the speaker and a surface of a frame 16 which is opposite the surface of the cabinet 12 (i.e., a gap having the width ranged from several to a dozen or so mm between the surface of the cabinet and the frame). It is noted that this space is indicated by “GAP” in FIG. 2. As illustrated in FIG. 2, the gap is open to a space outside the side face of the speaker, and the sound waves having entered into this gap radiate from this open end B toward the space outside the side face of the speaker. Since acoustic impedance greatly fluctuates at this open end B, what is called “reflection of sound at the open end” occurs. The sound reflected by the reflection of sound at the open end (indicated by the broken line in FIG. 2) propagates in a direction opposite from the direction of travel of the sound waves having entered in the gap, then radiates to the space in front of the speaker, and overlaps the sound directly transmitted from the speaker units 14.

Since the reflected sound is caused by the reflection of sound at the open end, the phase of the reflected sound is displaced by an amount corresponding to a half-wavelength with respect to the phase of the directly transmitted sound. This makes it possible to consider that distribution of sound pressure with nodes and antinodes as in the acoustic mode occurs in the space in front of the speaker (see FIG. 3A). Furthermore, it is possible to consider that the dips and the peaks appear due to the distribution of sound pressure. This is because it is considered that in a case where the frame 16 is not mounted, the reflection of sound at the open end does not occur, and accordingly, as illustrated in FIG. 3B, the sound pressure in the space in front of the speaker monotonously decreases with decrease in distance from an edge portion of the cabinet, with the directional axis D of the speaker units 14 being as a center. It is noted that a simulation performed by the present inventors has shown that the distribution of sound pressure with nodes and antinodes as in the acoustic mode occurs in the space in front of the speaker. On the basis of the result of the experiment, the consideration, and the result of the simulation, the inventors of the present invention have concluded that sound directly transmitted from the speaker and reflected wave generated by the reflection of sound at open end which occurs at the open end (opening to the outside space) of the gap defined between the cabinet 12 and the frame 16 interact with each other, whereby distribution of sound pressure as in the acoustic mode occurs, which deteriorates sound quality.

### Embodiment

There will be next explained a speaker according to one embodiment of the present invention with reference to drawings.

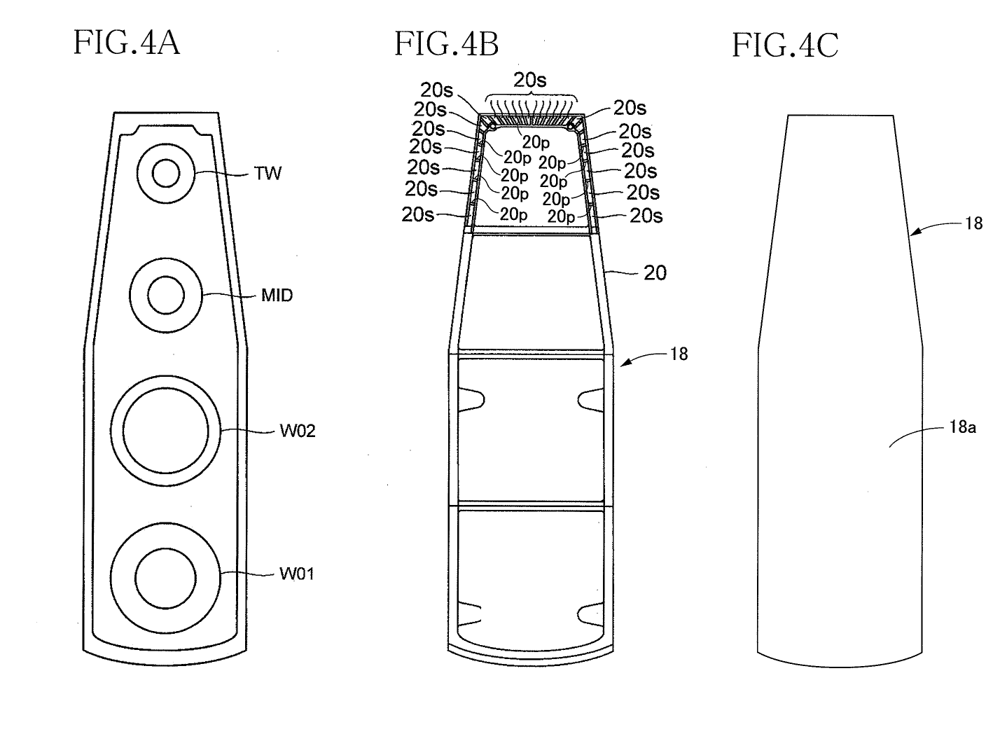

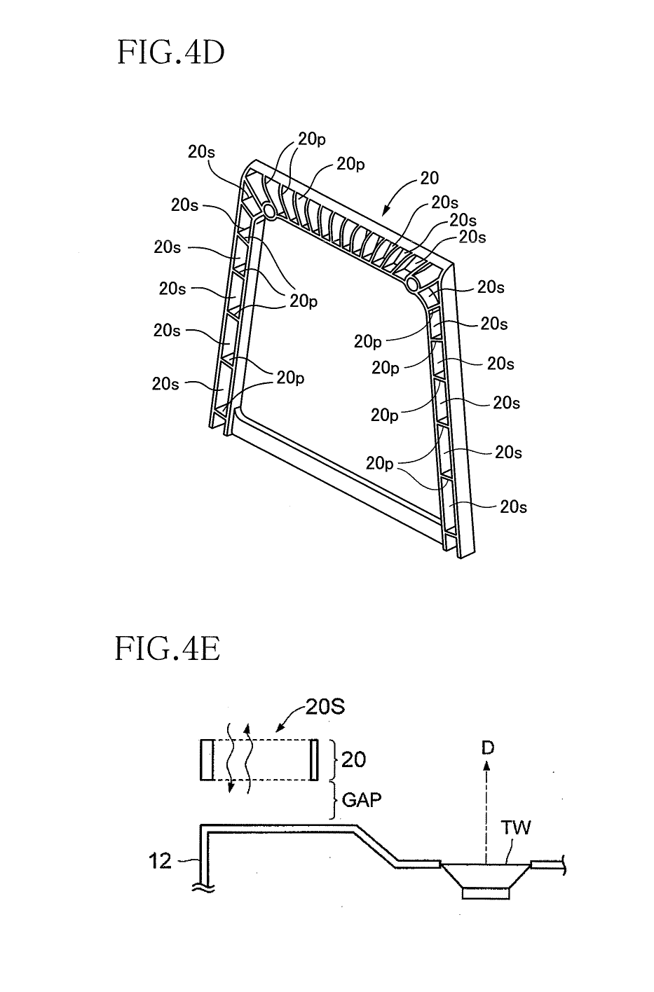

FIG. 4A is a front elevational view of the speaker according to one embodiment of the present invention. For simplicity, FIG. 4A illustrates the speaker from which a speaker net or grille is removed. The speaker according to the present embodiment includes four speaker units, as at least one speaker unit, mounted on a cabinet so as to be arranged in a row in the vertical direction. Specifically, the four speaker units mounted on the cabinet are a first woofer WO1, a second woofer WO2, a squawker or a mid-range driver MID, and a tweeter TW in the order from below. The squawker is a speaker or driver that reproduces sound in the frequency range from approximately 500 to 5000 Hz. The woofer is a speaker that reproduces lower audio frequency sound than the squawker, and the tweeter is a speaker that reproduces higher audio frequency sound than the squawker.

FIG. 4B is a front elevational view of a speaker net 18 mounted on the speaker illustrated in FIG. 4A. FIG. 4B omits illustration of a sheet member 18a for simplicity. FIG. 4C is a front elevational view of the speaker net 18 on which the sheet member 18a is placed. The speaker net 18 according to the present embodiment includes: a frame 20 mounted on the cabinet for the speaker; and the sheet member 18a (not shown in FIG. 4B) stuck on the frame 20 so as to cover sound emitting surfaces of the respective speaker units. The frame 20 has a portion surrounding the sound emitting surface of the tweeter TW, and the portion of the frame 20 has a plurality of through holes for establishing communication between (a) a space defined between the cabinet and the frame 20 and (b) an outside space existing in front of the speaker. FIG. 4D is an enlarged perspective view illustrating the portion of the frame 20 which surrounds the sound emitting surface of the tweeter TW. In the present embodiment, as illustrated in FIGS. 4B and 4D, the portion of the frame 20 includes a plurality of partitions 20p which define a plurality of slits 20S as the through holes which are separated from each other, that is, the slits 20S and the partitions 20p form a ladder shape. The plurality of slits 20S are arranged in a direction in which the frame 20 extends. These through holes in the form of the slits 20S in the present embodiment are provided for preventing the deterioration of sound quality based on the consideration. These through holes are formed only for the tweeter TW because the deterioration of the sound quality is noticeable in frequencies contained in the frequency range of sound reproduced by the tweeter TW.

In the present embodiment, the portion of the frame 20 which surrounds the sound emitting surface of the tweeter TW has the through holes in the form of the slits 20S for establishing the communication between (a) the space defined between the cabinet and the frame 20 and (b) the outside space existing in front of the speaker. Thus, the space defined between the cabinet and the frame 20 communicates via the slits 20S with the outside space existing in front of the speaker and is thereby united with the outside space (see FIG. 4E). In this construction, acoustic impedance does not fluctuate greatly at the open end of the side face of the speaker, preventing an occurrence of reflection of sound at the open end. Thus, the distribution of sound pressure with nodes and antinodes as in the acoustic mode does not noticeably occur in the outside space existing in front of the speaker. It is noted that the through holes are not limited to the slits having the ladder shape illustrated in FIG. 4B and may be round holes formed by a drill, for example. The number of the through holes may be determined as appropriate according to the strength required for the frame 20. Though a single through hole may of course be formed, it is considered that the unity of the space defined between the cabinet and the frame 20 and the outside space existing in front of the speaker increases with increase in a ratio of the area of the through hole or holes to the surface area of the frame 20 (i.e., an aperture ratio). Accordingly, higher effects can be obtained as the aperture ratio increases as long as the frame 20 has such a strength that the frame 20 is not distorted by, e.g., a tension generated when the sheet member is stuck to the frame by adhesives or other similar materials.

In addition or instead of the portion of the frame 20 which surrounds the sound emitting surface of the tweeter TW, a plurality of through holes 20S may be formed in a portion of the frame 20 which differs from the portion of the frame 20 which surrounds the sound emitting surface of the tweeter TW.

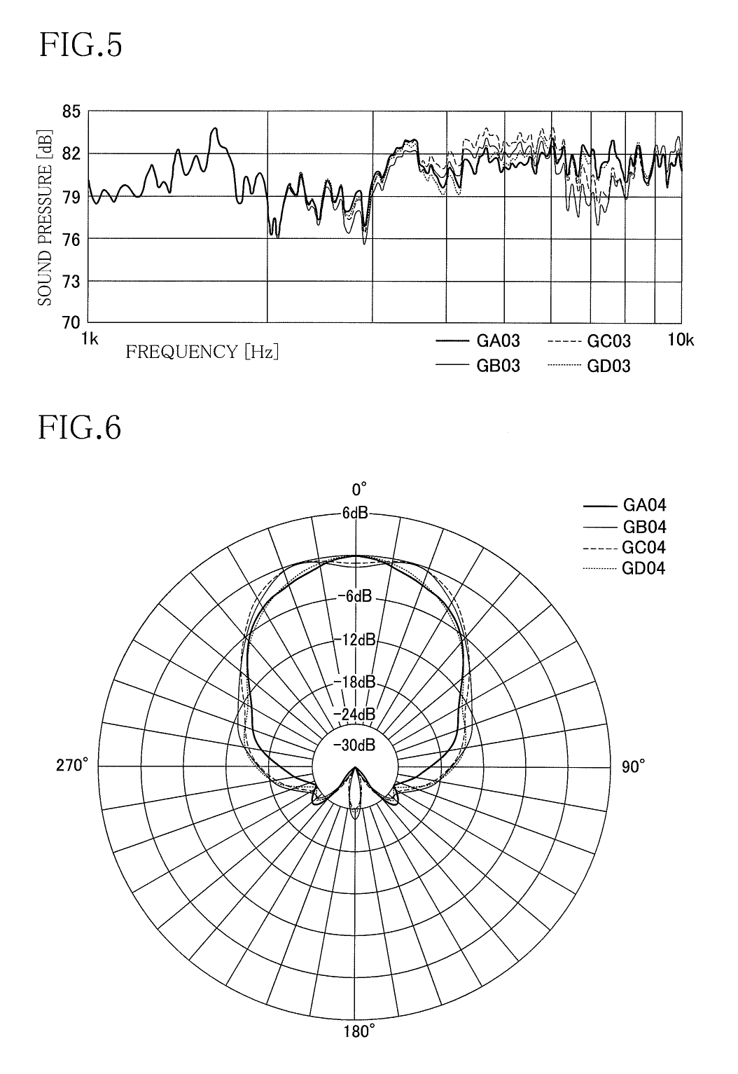

FIG. 5 illustrates graphs representing frequency characteristics in a range from 1-10 kHz in a case (A) where the speaker net is not mounted, in a case (B) where the conventional speaker net is mounted, in a case (C) where only the conventional frame is mounted, and in a case (D) where the frame 20 in the present embodiment is mounted. A graph GA03 in FIG. 5 represents frequency characteristics in the case (A) where the speaker net is not mounted. A graph GB03 in FIG. 5 represents frequency characteristics in the case (B) where the conventional speaker net is mounted. A graph GC03 in FIG. 5 represents frequency characteristics in the case (C) where only the conventional frame is mounted. A graph GD03 in FIG. 5 represents frequency characteristics in the case (D) where the frame 20 in the present embodiment is mounted. In FIG. 5, the graph GD03 generally overlaps the graph GA03, which shows that the present embodiment eliminates the peaks and the dips in the high frequency range and thereby suppresses the deterioration of sound quality.

FIG. 6 illustrates directional characteristics of sound at 7 kHz in the cases (A)-(D). A graph GA04 in FIG. 6 represents directional characteristics in the case (A) where the speaker net is not mounted. A graph GB04 in FIG. 6 represents directional characteristics in the case (B) where the conventional speaker net is mounted. A graph GC04 in FIG. 6 represents directional characteristics in the case (C) where only the conventional frame is mounted. A graph GD04 in FIG. 6 represents directional characteristics in the case (D) where the frame 20 in the present embodiment is mounted. In FIG. 6, the graph GD04 generally overlaps the graph GA04, which shows that the directional characteristics are improved.

With the above-described construction in which the speaker net 18 includes the frame 20 in the present embodiment, it is possible to avoid deterioration of sound quality of reproduced sound. That is, in the present embodiment, it is possible to both protect the speaker units and avoid deterioration of sound quality.

### Modifications

While the embodiment of the present invention has been described above, it is to be understood that the invention is not limited to the details of the illustrated embodiment, but may be embodied with various changes and modifications, which may occur to those skilled in the art, without departing from the spirit and scope of the invention.

While the frame having the characteristics of the above-described embodiment is mounted on the cabinet for storing the speaker units in the above-described embodiment, the frame may be mounted on at least one of the speaker units. While the present invention is applied to the speaker in which the speaker units of various types are stored in the cabinet in a state in which the sound emitting surfaces of the respective speaker units are arranged in a line in the above-described embodiment, the present invention may be applied to a speaker in which a plurality of speaker units having the same frequency range of reproduced sound are stored in the cabinet, for example, the present invention may be applied to a speaker array. In this construction, since the speaker units have the same frequency range of reproduced sound, the entire frame is formed, for example, to have through holes for establishing communication between (a) a space between the cabinet and the frame and (b) the outside space.

The present invention may be applied to a speaker in which only one speaker unit is stored in the cabinet. Specifically, one example of such a speaker includes: a speaker unit; a cabinet accommodating the speaker unit; and a speaker net mounted on the cabinet or the speaker unit so as to cover a sound emitting surface of the speaker unit, wherein the speaker net includes: a frame surrounding the sound emitting surface of the speaker unit; and a sheet member stuck to the frame so as to cover the sound emitting surface of the speaker unit, and wherein the frame is formed with at least one through hole for establishing communication between (i) a space between the cabinet and the frame and (ii) an outside space.

A speaker net may be offered alone which includes: a frame surrounding a sound emitting surface of at least one speaker unit; and a sheet member stuck to the frame so as to cover the sound emitting surface of the at least one speaker unit, wherein the frame is formed with at least one through hole for establishing communication between (i) a space between a cabinet and the frame and (ii) an outside space. For example, various types of speaker nets including sheet members having respective different materials, textures, or colorings are placed on the market as speaker nets mountable on a particular speaker. This situation allows users of the speaker to choose and use a speaker net that matches (i) an atmosphere of a room in which the speaker is placed and (ii) other pieces of furniture in the room.

What is claimed is:

1. A speaker comprising:
one or more speaker units;
a cabinet accommodating the one or more speaker units; and
a speaker net mounted on one of the cabinet and at least one of the one or more speaker units so as to cover a sound emitting surface of each of the at least one of the one or more speaker units,
the speaker net comprising:
a frame surrounding the sound emitting surface of each of the at least one of the one or more speaker units; and
a sheet member stuck to the frame to cover the sound emitting surface of each of the at least one of the one or more speaker units,
the frame being formed with at least one through hole establishing communication between (i) a space between the frame and the cabinet and (ii) a space outside the speaker.

2. The speaker according to claim 1, further comprising a plurality of speaker units as the one or more speaker units,
wherein the cabinet accommodates the plurality of speaker units such that respective sound emitting surfaces of the plurality of speaker units are arranged,
wherein the speaker net is mounted on one of the cabinet and at least one of the plurality of speaker units to cover at least one of the respective sound emitting surfaces of the plurality of speaker units,
wherein the frame surrounds the at least one of the respective sound emitting surfaces of the plurality of speaker units, and
wherein the sheet member is stuck to the frame to cover the at least one of the respective sound emitting surfaces of the plurality of speaker units.

3. The speaker according to claim 2, wherein the at least one through hole is formed in a portion of the frame which surrounds the at least one of the respective sound emitting surfaces of the plurality of speaker units.

4. The speaker according to claim 3,
wherein one of the plurality of speaker units is a tweeter, and
wherein the at least one through hole is formed only in a portion of the frame which surrounds a sound emitting surface of the tweeter.

5. The speaker according to claim 1,
wherein the frame is formed with a plurality of through holes each as the at least one through hole, and
wherein the plurality of through holes are arranged in a direction in which the frame extends.

6. The speaker according to claim 5, wherein the plurality of through holes are formed in the frame and separated from each other by a plurality of partitions arranged in a direction in which the frame extends.

7. The speaker according to claim 1, wherein the at least one through hole is formed through the frame in a direction parallel to a directional axis of the one or more speaker units.

8. A speaker net to be mounted on one of a cabinet accommodating one or more speaker units and at least one of the one or more speaker units to cover a sound emitting surface of each of the at least one of the one or more speaker units, the speaker net comprising:
a frame surrounding the sound emitting surface of each of the at least one of the one or more speaker units; and
a sheet member stuck to the frame to cover the sound emitting surface of each of the at least one of the one or more speaker units,
the frame being formed with at least one through hole establishing communication between (i) a space between the frame and the cabinet and (ii) a space outside the speaker.

9. The speaker net according to claim 8,
wherein the speaker net is to be mounted on one of the cabinet accommodating a plurality of speaker units as the one or more speaker units and at least one of the plurality of speaker units to cover at least one of respective sound emitting surfaces of the plurality of speaker units,
wherein the frame surrounds the at least one of the respective sound emitting surfaces of the plurality of speaker units, and
wherein the sheet member surrounds the at least one of the respective sound emitting surfaces of the plurality of speaker units.

10. The speaker net according to claim 9, wherein the at least one through hole is formed in a portion of the frame which surrounds the at least one of respective sound emitting surfaces of the plurality of speaker units.
